(19) United States
(12) Patent Application Publication
(10) Pub. No.: US 2014/0014787 A1
(43) Pub. Date: Jan. 16, 2014

(54) CABLE ORGANIZER STRUCTURE

(71) Applicant: Kevin Fong Chen, Anaheim, CA (US)

(72) Inventor: Kevin Fong Chen, Anaheim, CA (US)

(73) Assignee: Kevin Fong Chen, Anaheim, CA (US)

(21) Appl. No.: 13/545,006

(22) Filed: Jul. 10, 2012

(51) Int. Cl. F16L 3/10

(52) U.S. Cl. 248/74.1

(57) ABSTRACT

A cable organizer unit includes a foam structure main body. The foam structure main body has a base section, a first extension end and a second extension end. The first and second extension ends respectively extend from two sides of the base section toward the middle of the base section. Each of the first and second extension ends having a free end. The free ends of the first and second extension ends are adjacent to each other. The first and second extension ends and the base section together define a receiving space. By means of the cable organizer unit, the cable can be easily and quickly fixed.

### BACKGROUND OF THE INVENTION

1. Field of the Invention

The present invention relates generally to a cable organizer unit, and more particularly to a cable organizer unit, which has very good flexibility and is convenient to use for quickly fixing the cable.

2. Description of the Related Art

It is always a bothering thing to arrange cables. In consideration of safety, it is often necessary to extend various cables such as extension cable, network cable, power cable and mouse cable from a position or one end to another position or another end in an elongated path. In the case that the cables are scattered on the ground without being well fixed on a wall, the cables will become visual nuisance to ruin the appearance. Moreover, dust will accumulate on the cables to make the cables an unsavory place and contaminate the environment. On the other hand, as to the efficiency, it is quite inconvenient for a user to find a cable to be replaced from the tangling cables. Also, a user may be stumbled by the randomly arranged cables to pull down an electrical appliance or pull off the cables. This may lead to the danger of short-circuiting or electrical leakage.

Various cable organizer products are commercially available nowadays, such as the often seen cable tie, hub tube, cable winder and cable collector. These cable organizers can be used to organize and fix elongated cables. However, these products lead to extra expense of a user. Moreover, with respect to the cable winder and cable collector, the structure is relatively complicated so that the manufacturing cost is relatively high. As a result, such products are considerably expensive. As to the cable tie and hub tube, the structure is simpler so that the price of such products is lower. However, in use of such products, a user needs to troublesomely tie up the cables with the cable tie. Moreover, after tied, it is hard to untie the cables. In some cases, it is necessary to directly cut off the cable tie for untying the cables. Under such circumstance, it is impossible to reuse the cable tie. This leads to plastic waste and fails to meet the modern requirement of environmental protection.

FIG. 1A shows an existent cable organizer unit in the form of a strip. Such cable organizer unit is made of hard plastic material. Accordingly, the cable organizer unit can be only arranged in a linear path or an angled path and cannot be freely curved. Moreover, it is necessary to use an additional tool to cut the cable organizer unit. Also, when mounted, the cable organizer unit must be co-used with an accessory. This leads to higher expense and it is time-consuming and troublesome to mount the cable organizer unit. In addition, the use of the cable organizer unit is quite limited and a user is likely to misuse the cable organizer unit to cause waste or poor appearance. Besides, it is very troublesome to replace the cable.

FIGS. 1B, 1C and 1D are perspective views showing three types of cable organizer units often seen in the market, including screw-locked type, staple gun type and nailing type. FIG. 1B shows a nailing type of cable organizer unit 1 including a base section 10, a first extension end 101 and a second extension end 102. The first and second extension ends 101, 102 respectively extend from two ends of the base section 10. The first and second extension ends 101, 102 and the base section 10 together define a receiving space 103. In comparison with the cable organizer unit shown in FIG. 1A, all the three types of cable organizer units are cheaper. However, in use of these cable organizer units, it is necessary to nail the cable organizer units on a wall or lock the cable organizer units by means of a screw. This will lead to damage of the wall face or the structures of the cable organizer units. Moreover, it is necessary to additionally use a hammer or a screwdriver to mount the cable organizer units onto the wall. The cable organizer unit has a tiny volume so that it often takes place that a user's fingers get injured when mounting the cable organizer unit with the tool. Therefore, it is dangerous, time-consuming and inconvenient to use the tool to mount the cable organizer unit. Moreover, after mounted, in case of replacement of the cable, it is necessary to totally detach the cable organizer unit from the wall and remount a new cable organizer unit onto the wall. This will leave pits or marks on the wall and it is impossible to remount the cable organizer unit on the wall in the original position. Also, the cable organizer unit 1 is made of a material without flexibility. Therefore, after a user fixes the cable organizer unit 1 on a plane face, it is hard for the user to remove or replace the cable.

According to the above, the conventional cable organizer unit has the following shortcomings:
1. The conventional cable organizer unit is not flexible.
2. It is hard to mount the conventional cable organizer unit.
3. It is relatively dangerous to mount the conventional cable organizer unit.
4. It is inconvenient to use the conventional cable organizer unit.

### SUMMARY OF THE INVENTION

It is therefore a primary object of the present invention to provide a cable organizer unit, which has very good flexibility and is convenient to use for quickly fixing the cable.

It is a further object of the present invention to provide the above cable organizer unit, which can be conveniently mounted to fix the cable and ensure safety. Moreover, after mounted, the cable can be easily removed from the cable organizer unit or replaced.

To achieve the above and other objects, the cable organizer unit includes a foam structure main body. The foam structure main body has a base section, a first extension end and a second extension end. The first and second extension ends respectively extend from two sides of the base section toward the middle of the base section. Each of the first and second extension ends having a free end. The free ends of the first and second extension ends are adjacent to each other. The first and second extension ends and the base section together define a receiving space.

The foam structure main body is made of a material selected from a group consisting of rubber, sponge, polyurethane (PU), polypropylene (PP), polyethylene (PE), ethylene vinyl acetate (EVA), polystyrene (PS) and nylon.

The foam structure main body is made of a flexible material so that the cable organizer unit has very good flexibility and is very convenient to use for quickly fixing and organizing the cable.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1A is a perspective view of a conventional cable organizer unit;

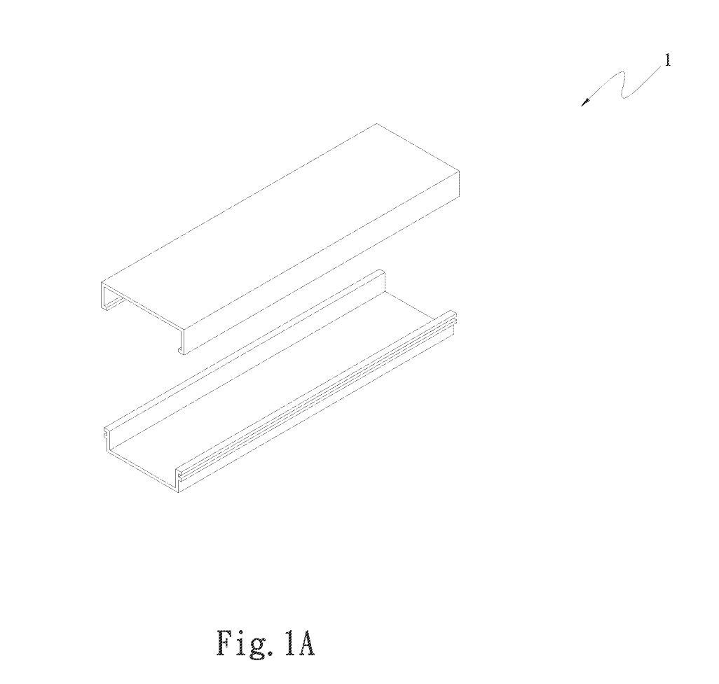

FIG. 1B is a perspective view of another conventional cable organizer unit;

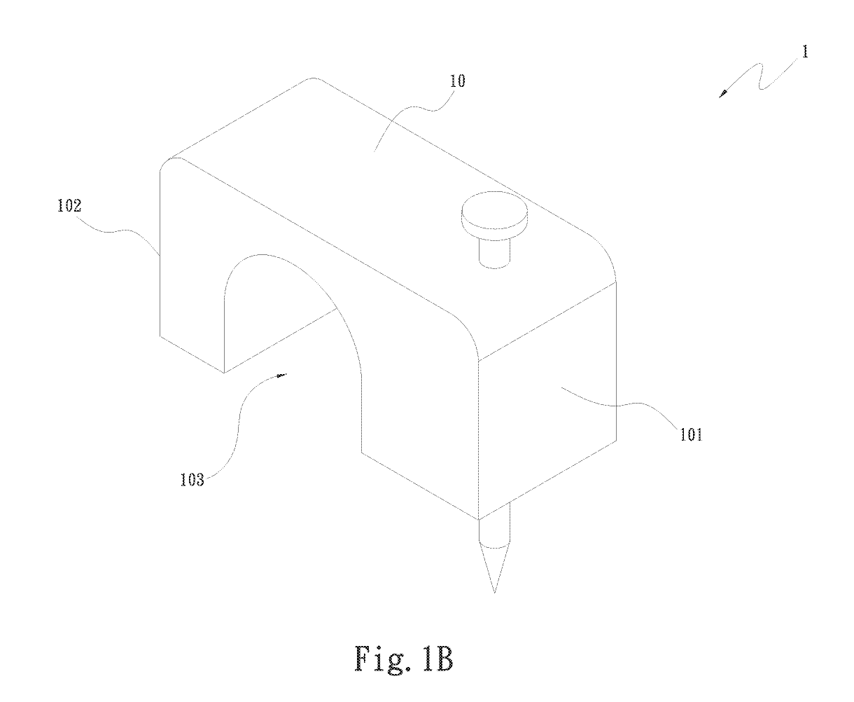

FIG. 1C is a perspective view of still another conventional cable organizer unit;

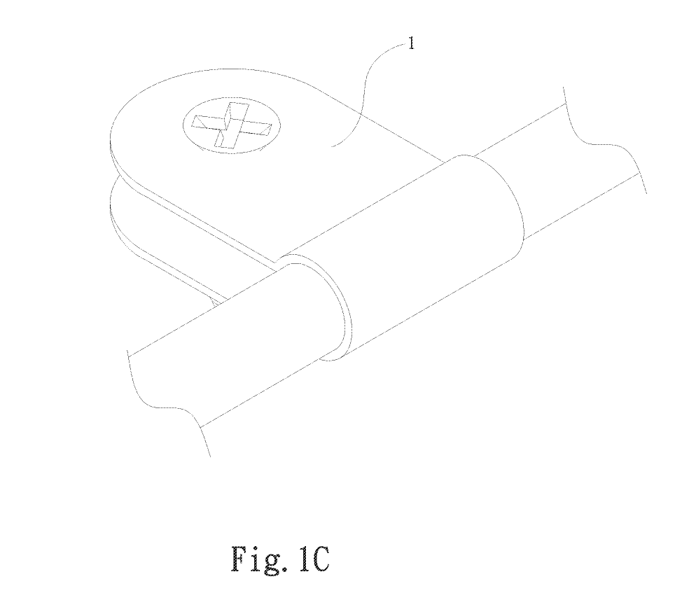

FIG. 1D is a perspective view of still another conventional cable organizer unit;

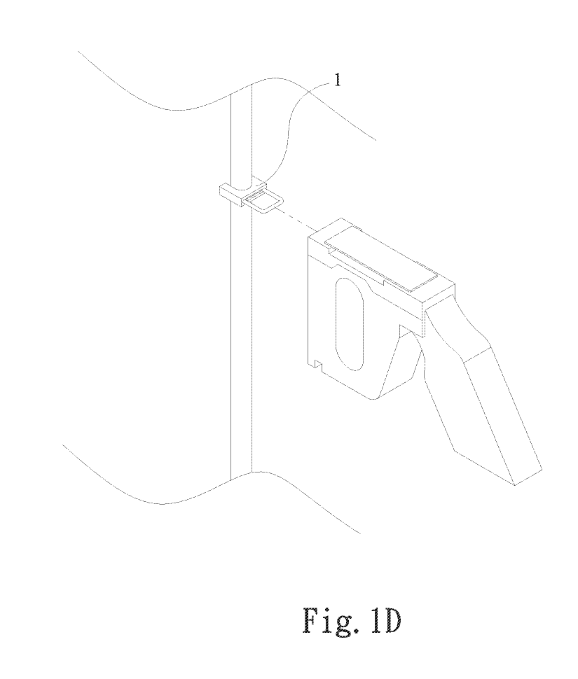

FIG. 2A is a perspective view of a first embodiment of the cable organizer unit of the present invention;

FIG. 2B is a front view of the first embodiment of the cable organizer unit of the present invention;

FIG. 2C is another front view of the first embodiment of the cable organizer unit of the present invention;

FIG. 3 is a front view of a second embodiment of the cable organizer unit of the present invention;

FIG. 4A is a perspective view of a third embodiment of the cable organizer unit of the present invention;

FIG. 4B is a front view of the third embodiment of the cable organizer unit of the present invention;

FIG. 4C is a perspective view of the third embodiment of the cable organizer unit of the present invention, showing the use thereof;

FIG. 5 is a perspective view of a fourth embodiment of the cable organizer unit of the present invention;

FIG. 6 is a perspective view of a fifth embodiment of the cable organizer unit of the present invention;

FIG. 7 is a perspective view of a sixth embodiment of the cable organizer unit of the present invention; and

FIG. 8 is a perspective view of a seventh embodiment of the cable organizer unit of the present invention.

### DETAILED DESCRIPTION OF THE PREFERRED EMBODIMENTS

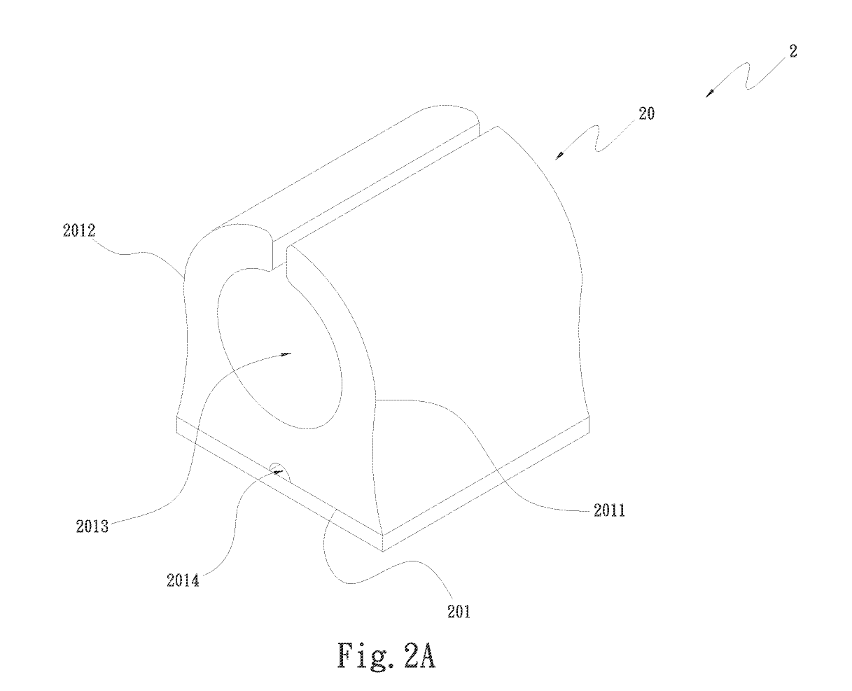

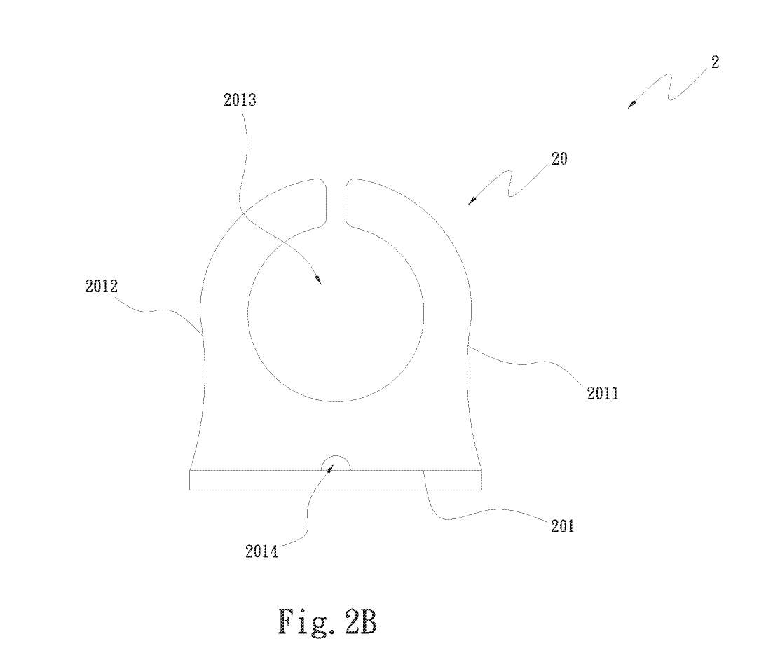

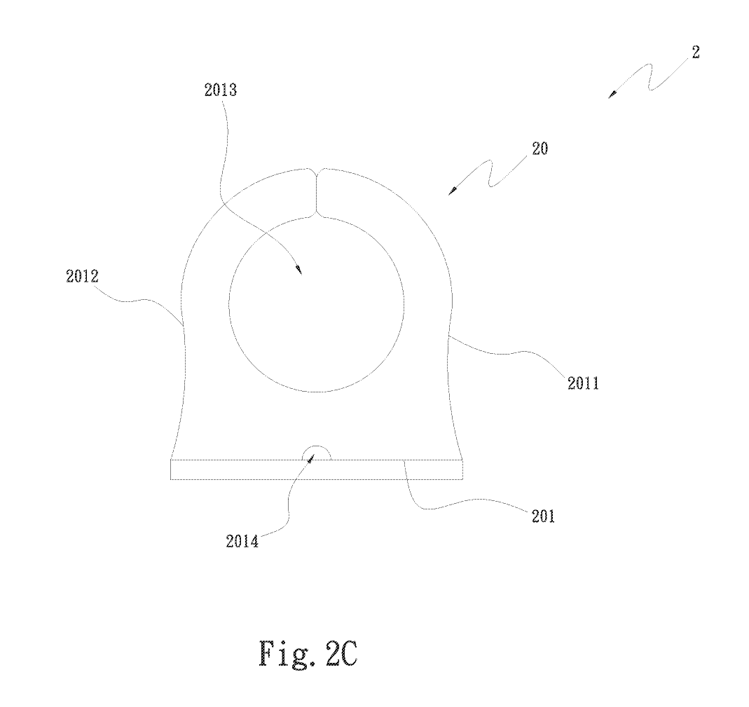

Please refer to FIGS. 2A, 2B and 2C. FIG. 2A is a perspective view of a first embodiment of the cable organizer unit of the present invention. FIG. 2B is a front view of the first embodiment of the cable organizer unit of the present invention. FIG. 2C is another front view of the first embodiment of the cable organizer unit of the present invention. According to the first embodiment, the cable organizer unit 2 of the present invention includes a foam structure main body 20 having a base section 201. A first extension end 2011 and a second extension end 2012 respectively extend from two sides of the base section 201. The first and second extension ends 2011, 2012 respectively extend from two sides of the base section 201 toward the middle of the base section 201. Each of the first and second extension ends 2011, 2012 has a free end. The free ends of the first and second extension ends 2011, 2012 are adjacent to each other. The first and second extension ends 2011, 2012 and the base section 201 together define a receiving space 2013. A channel 2014 is formed on one side of the base section 201, which side is opposite to the receiving space 2013.

The material of the foam structure main body 20 is selected from a group consisting of rubber, sponge, polyurethane (PU), polypropylene (PP), polyethylene (PE), ethylene vinyl acetate (EVA), polystyrene (PS) and nylon. The surface of the foam structure main body 20 has the property of paint adsorption. Therefore, the foam structure main body 20 can be colored as the color of a wall and concealed. In addition, the foam structure main body 20 is flexible.

The free ends of the first and second extension ends 2011, 2012 can be alternatively in contact with each other (as shown in FIG. 2C).

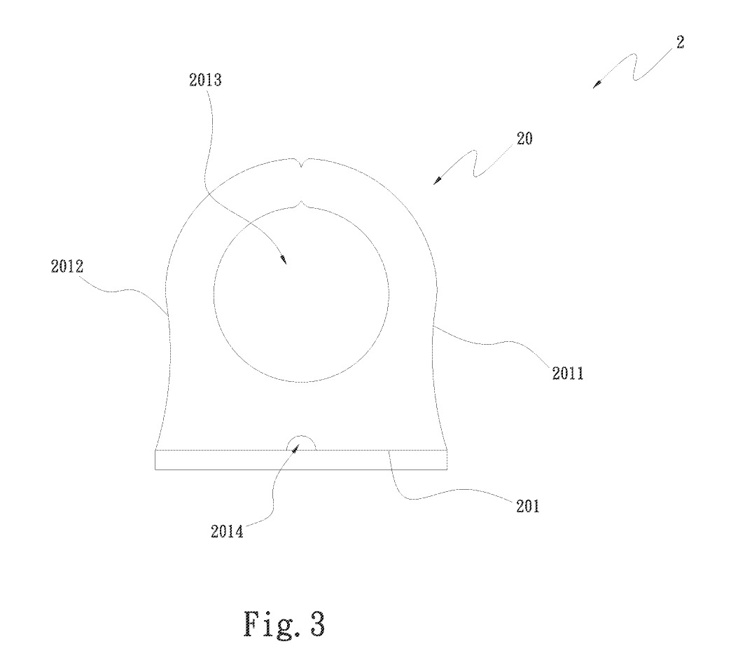

Please now refer to FIG. 3, which is a front view of a second embodiment of the cable organizer unit of the present invention. The second embodiment is partially identical to the first embodiment in component and relationship between the components and thus will not be repeatedly described hereinafter. The second embodiment is mainly different from the first embodiment in that the free ends of the first and second extension ends 2011, 2012 are adhered to each other by means of plastic extrusion molding or high temperature fusion. In the case of plastic extrusion molding, the free ends of the first and second extension ends 2011, 2012 are easily separably adhered to each other. Under such circumstance, even after the free ends of the first and second extension ends 2011, 2012 are separated from each other, the cable organizer unit will restore to their home positions in adjacency to each other due to the flexibility of the material of the cable organizer unit. Accordingly, the cables are totally enclosed in the receiving space 2013 without dropping out or being exposed to outer side.

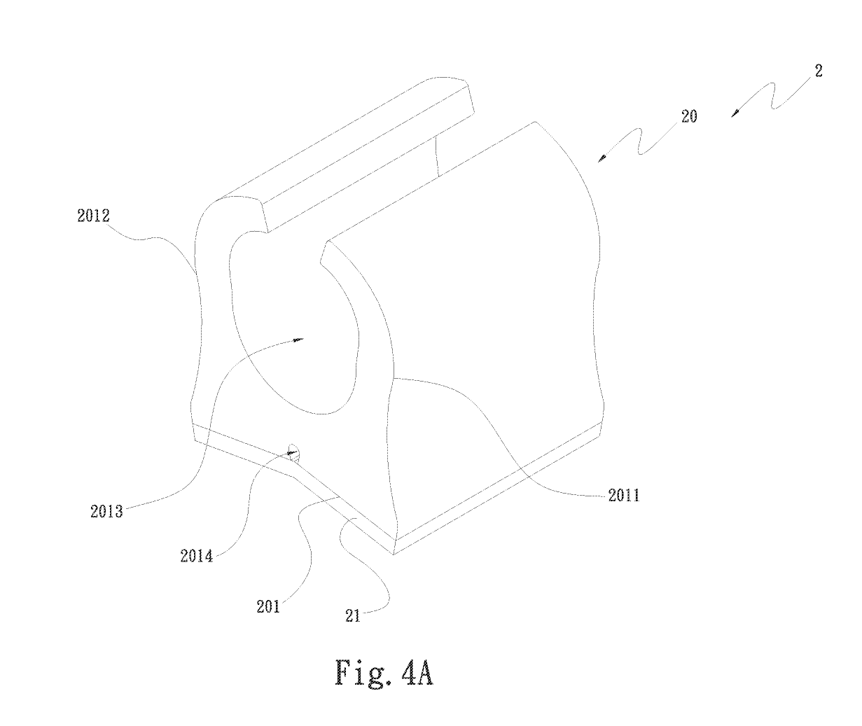

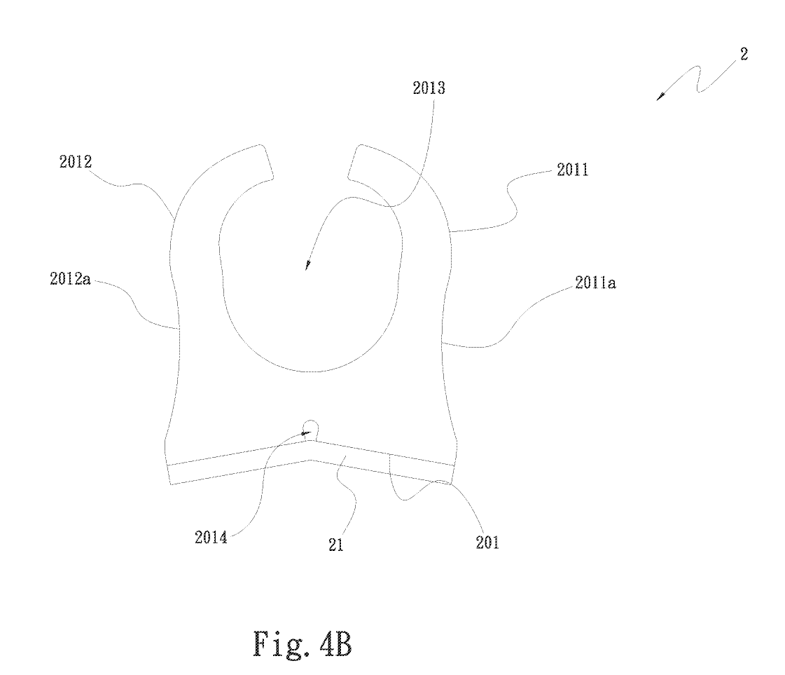

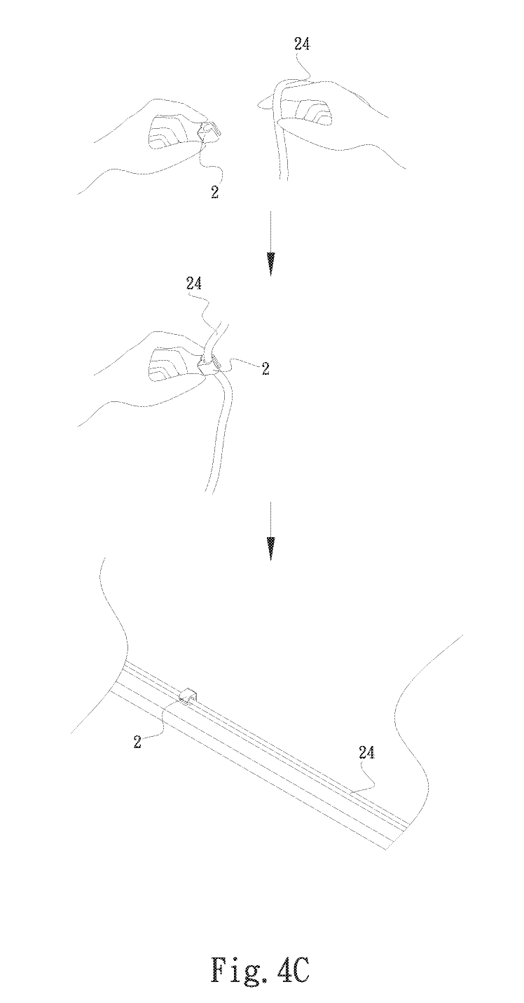

Please now refer to FIGS. 4A, 4B and 4C. FIG. 4A is a perspective view of a third embodiment of the cable organizer unit of the present invention. FIG. 4B is a front view of the third embodiment of the cable organizer unit of the present invention. FIG. 4C is a perspective view of the third embodiment of the cable organizer unit of the present invention, showing the use thereof. The third embodiment is partially identical to the first embodiment in component and relationship between the components and thus will not be repeatedly described hereinafter. The third embodiment is mainly different from the first embodiment in that a first recessed section 2011a is formed on outer side of the junction between the first extension end 2011 and the base section 201 and a second recessed section 2012a is formed on outer side of the junction between the second extension end 2012 and the base section 201. As aforesaid, the cable organizer unit 2 is flexible and formed with the channel 2014 on one side of the base section 201, which side is opposite to the receiving space 2013. In use of the cable organizer unit 2, a user can hold the first and second recessed sections 2011a, 2012a with two fingers (as shown in FIG. 4C) and apply an external force to the first and second recessed sections 2011a, 2012a. At this time, the first and second ends 2011, 2012 will be biased outward. In addition, the channel 2014 will be compressed and deformed under the external force, whereby the receiving space 2013 is opened. Under such circumstance, the cable 24 can be placed into the receiving space 2013. Then, the cable organizer unit is released from the external force. After the external force disappears, the free ends of the first and second extension ends 2011, 2012 can automatically restore to their home positions and close the receiving space 2013 due to the flexibility of the cable organizer unit 2. Then, the cable organizer unit 2 can be attached to a desired position to fix the cable therein. Accordingly, the cable organizer unit 2 serves as a clip. Moreover, after mounted, the cable can be removed or replaced without detaching the cable organizer unit 2. Also, even after the cable organizer unit 2 is attached to any plane face, the cable organizer unit 2 still has very good flexibility. In addition, the opening of the cable organizer unit 2 is positioned on the other side opposite to the base section 201. Therefore, when an external force is applied to the free ends of the first and second extension ends 2011, 2012, the free ends of the first and second extension ends 2011, 2012 can be easily temporarily moved away from each other to open the receiving space 2013. Under such circumstance, the cable can be removed or replaced without detaching the cable organizer unit 2.

In addition, the side of the base section 201 with the channel 2014 has a self-adhesive material 21. By means of the self-adhesive material 21, a user can freely detachably attach the cable organizer unit 2 onto any plane face of any material. In contrast, the conventional cable organizer unit necessitates an additional tool such as a hammer for fixing the cable organizer unit 2. This will lead to damage of the plane face or leave a pit or a mark on the plane face to ruin the appearance. Moreover, a user's fingers are likely to get injured when using the tool to mount the cable organizer unit onto the plane face.

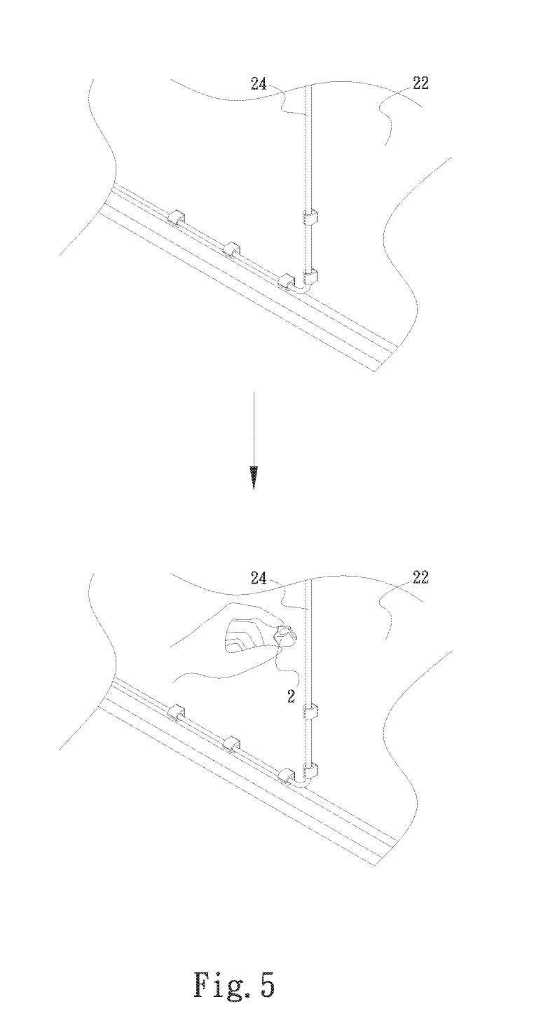

Please now refer to FIG. 5, which is a perspective view of a fourth embodiment of the cable organizer unit of the present invention. The fourth embodiment is partially identical to the first embodiment in component and relationship between the components and thus will not be repeatedly described hereinafter. The fourth embodiment is mainly different from the first embodiment in that the cable organizer unit 2 has a small volume and is lightweight. Therefore, in use of the cable organizer unit 2, a user can freely attach the cable organizer units 2 on a wall face in a turning path to conveniently fix the cable.

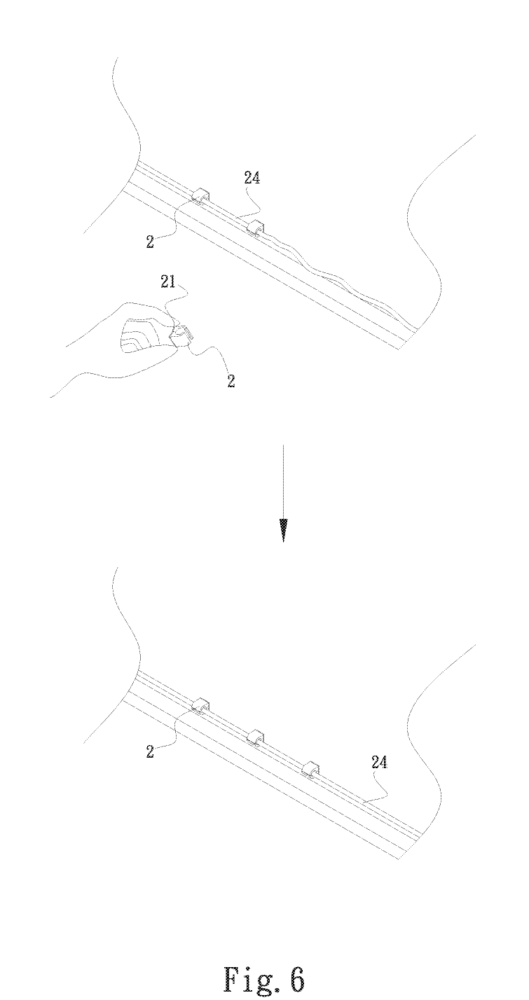

Please now refer to FIG. 6, which is a perspective view of a fifth embodiment of the cable organizer unit of the present invention. The fifth embodiment is partially identical to the first embodiment in component and relationship between the components and thus will not be repeatedly described hereinafter. The fifth embodiment is mainly different from the first embodiment in that in the case of a wall face 22 with a randomly arranged cable 24, a user can directly use the cable organizer unit 2 to hold the cable 24 and attach the cable organizer unit 2 onto the wall face 22 in a desired position by means of the self-adhesive material 21. Accordingly, the cable can be easily and conveniently organized and fixed on the wall face.

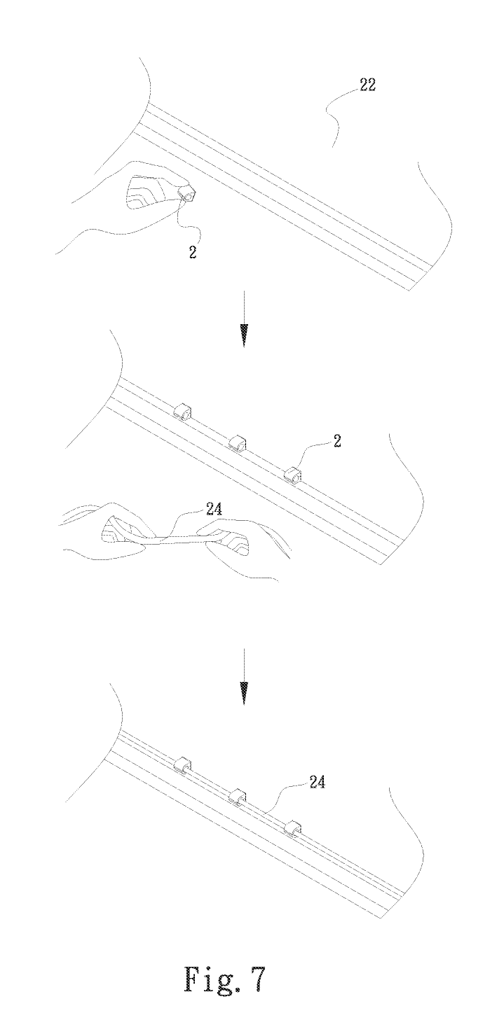

Please now refer to FIG. 7, which is a perspective view of a sixth embodiment of the cable organizer unit of the present invention. The sixth embodiment is partially identical to the first embodiment in component and relationship between the components and thus will not be repeatedly described hereinafter. The sixth embodiment is mainly different from the first embodiment in that a user can directly previously attach the cable organizer units 2 on a wall face 22 in a predetermined path of the cable by means of the self-adhesive material 21. Then the user can place the cable 24 into the receiving space 2013 of the cable organizer unit 2 to easily complete the installation. In contrast, the conventional cable organizer unit necessitates an additional tool for fixing the cable organizer unit on the wall. This will leave a pit or a mark on the wall face. Moreover, a user's fingers are likely to get injured when using the tool.

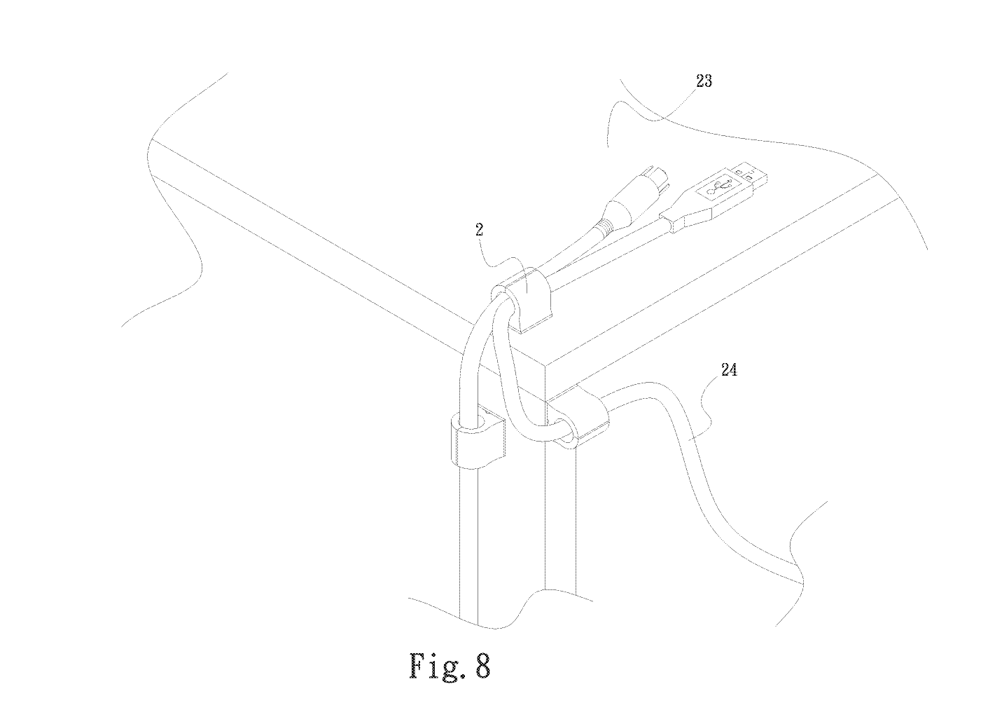

Please now refer to FIG. 8, which is a perspective view of a seventh embodiment of the cable organizer unit of the present invention. The seventh embodiment is partially identical to the first embodiment in component and relationship between the components and thus will not be repeatedly described hereinafter. The seventh embodiment is mainly different from the first embodiment in that by means of the self-adhesive material 21, the cable organizer units 2 can be fixedly attached to any plane face of any material in a winding path, such as metal, glass, plastic, stone or wooden material. Moreover, the cable organizer units 2 can be freely attached to the plane face of any furniture (such as a table 23) or the plane face of a window in a winding path without taking the material of the mounting face into consideration. Accordingly, the cable organizer units 2 can be used to mount the cable in any path by any angle in any position. Accordingly, the cable organizer units 2 can be conveniently used without limitation.

In conclusion, in comparison with the conventional technique, the present invention has the following advantages:
1. The present invention is flexible.
2. The present invention is easy to mount.
3. The present invention can ensure safety.
4. The present invention can be conveniently used.

The present invention has been described with the above embodiments thereof and it is understood that many changes and modifications in the above embodiments can be carried out without departing from the scope and the spirit of the invention that is intended to be limited only by the appended claims.

What is claimed is:

1. A cable organizer unit comprising a foam structure main body, the foam structure main body having a base section, a first extension end and a second extension end, the first and second extension ends respectively extending from two sides of the base section toward the middle of the base section, each of the first and second extension ends having a free end, the free ends of the first and second extension ends being adjacent to each other, the first and second extension ends and the base section together defining a receiving space.

2. The cable organizer unit as claimed in claim 1, wherein a first recessed section is formed on outer side of a junction between the first extension end and the base section and a second recessed section is formed on outer side of a junction between the second extension end and the base section.

3. The cable organizer unit as claimed in claim 1, wherein a channel is formed on one side of the base section, which side is opposite to the receiving space.

4. The cable organizer unit as claimed in claim 1, wherein a self-adhesive material is disposed on one side of the base section with the channel.

5. The cable organizer unit as claimed in claim 1, wherein the foam structure main body is made of a material selected from a group consisting of rubber, sponge, polyurethane (PU), polypropylene (PP), polyethylene (PE), ethylene vinyl acetate (EVA), polystyrene (PS) and nylon.

6. The cable organizer unit as claimed in claim 1, wherein the foam structure main body is flexible.

7. The cable organizer unit as claimed in claim 1, wherein the free ends of the first and second extension ends are in contact with each other.

8. The cable organizer unit as claimed in claim 1, wherein the free ends of the first and second extension ends are adhered to each other.

9. The cable organizer unit as claimed in claim 8, wherein the free ends of the first and second extension ends are adhered to each other by means of plastic extrusion molding or high temperature fusion.
